(19) United States
(12) Patent Application Publication
(10) Pub. No.: US 2018/0300823 A1
(43) Pub. Date: Oct. 18, 2018

(54) On-Demand Fuel Delivery Systems, Methods and Related Devices

(71) Applicant: FILLD, INC., Mountain View, CA (US)

(72) Inventors: Christopher Aubuchon, Palo Alto, CA (US); Scott Hempy, San Jose, CA (US); Robert Burtzlaff, Cupertino, CA (US)

(21) Appl. No.: 15/569,379

(22) PCT Filed: Apr. 28, 2016
(86) PCT No.: PCT/US2016/029705

§ 371 Date: Oct. 25, 2017

Related U.S. Application Data
(60) Provisional application No. 62/153,618, filed on Apr. 28, 2015.

(51) Int. Cl. G06Q 50/06; G06Q 10/06; G06Q 30/02; G06Q 20/32; G06Q 10/08

(52) U.S. Cl. CPC G06Q 50/06; G06Q 10/063116; G06Q 10/08345; G06Q 20/322; G06Q 30/0283

(57) ABSTRACT

A user on-demand fuel delivery system can include at least one fill vehicle having a fuel tank connected to an electronically readable fuel flow meter; and at least one server configured to receive user instructions for refill of a fuel tank, including actual or anticipated location of the fuel tank, and a time window for fuel refill, wherein the at least one server selects one of the fill vehicles and provides route and time information to the fill vehicle for refill of the fuel tank; wherein the electronically readable fuel flow meter provides fuel delivery volume data to the at least one server, and a payment receipt is generated. Interfaces and corresponding methods are also disclosed.

### TECHNICAL FIELD

The present disclosure relates generally to fuel delivery systems suitable for automobiles or other vehicles. On-demand purchase and delivery of fuel to customers through smartphone or other internet connection is described.

### BACKGROUND

Depending on operation, automobiles, trucks, motorcycles, or fuel storage tanks can require substantial amounts of fuel. Typically, operators of a vehicle drive to commercial gasoline stations having a range of fuel types for refill. Such gasoline stations are located at a fixed site with street access, equipped with multiple fuel pumping facilities, and generally allow payment with cash or credit cards.

While commercial gasoline stations can be convenient refueling options for some, many are closed late at night, or can require substantial line wait times. Further, outside of a few states that currently mandate refill by gasoline station attendants, most gasoline stations require self-refueling by the vehicle operator or occupant. In addition, fuel delivery to fixed site fuel tanks or semi-portable fuel tanks such as construction site generators can require risky transport of multiple fuel cans or use of a dedicated fuel transport vehicle.

### SUMMARY

A system and/or operating method for a user on-demand fuel delivery system includes one or more fill vehicles having fuel tanks connected to an electronically readable fuel flow meter. At least one server (which can include cloud or virtual servers) is arranged to receive user instructions for refill of a fuel tank, including actual or anticipated location of the fuel tank. In some embodiments the user uses an interactive software application that provides a time window for fuel refill. Depending on the particular user time selection, pricing adjustments can be made to reflect differing delivery costs and fill vehicle availability. The server selects one of the fill vehicles and provides route and time information to the fill vehicle driver for refill of the fuel tank, and the electronically readable fuel flow meter provides fuel delivery volume data to at least one server. After payment by the user to the fuel refill service provider or a third party payment service (e.g. credit or debit card company), a receipt is provided to the user.

In other embodiments, upon receiving a user request for fuel delivery to a fuel tank at a user identified location within a user determined time window, the identity of the user is verified. The user is provided with an estimated delivery time window and an estimated delivery and fuel cost. Resource availability to supply requested fuel to the user is assessed, and driver schedule and route (of the fill vehicle) is adjusted to ensure refill of the user fuel tank during the previously determined time window. After refill of the fuel tank, the electronically provided fuel volume delivery information is used for payment calculations.

### BRIEF DESCRIPTION OF DRAWINGS

FIG. 1A is a diagram showing a fuel delivery system according to an embodiment;

FIG. 1B is a diagram showing a fuel delivery system according to another embodiment;

FIG. 2 is a flow diagram showing a method according to an embodiment;

FIG. 3A to 3E are representative user accessible screens according to embodiments;

FIG. 4 is an illustration of driver route map to four selected vehicles that can be generated according to embodiments;

FIG. 5A is an illustration of a fill vehicle with modular fuel tanks according to an embodiment;

FIG. 5B is a schematic illustrating an embodiment of a fuel pump system for the fill vehicle according to an embodiment;

FIG. 6 is a cartoon illustrating pin selection of target vehicle to be fueled in a residential neighborhood according to an embodiment;

FIG. 7 illustrates representative gas price monitoring zones and selected gas station positions that can be included in embodiments;

FIG. 8 illustrates direct driver to user communication of a fuel receipt in the event of a communication, server, or cloud server failure according to an embodiment;

FIG. 9A is a block diagram showing selected fuel delivery components according to one particular embodiment; and

FIG. 9B is a diagram showing selected fuel delivery components according to another particular embodiment.

### DETAILED DESCRIPTION

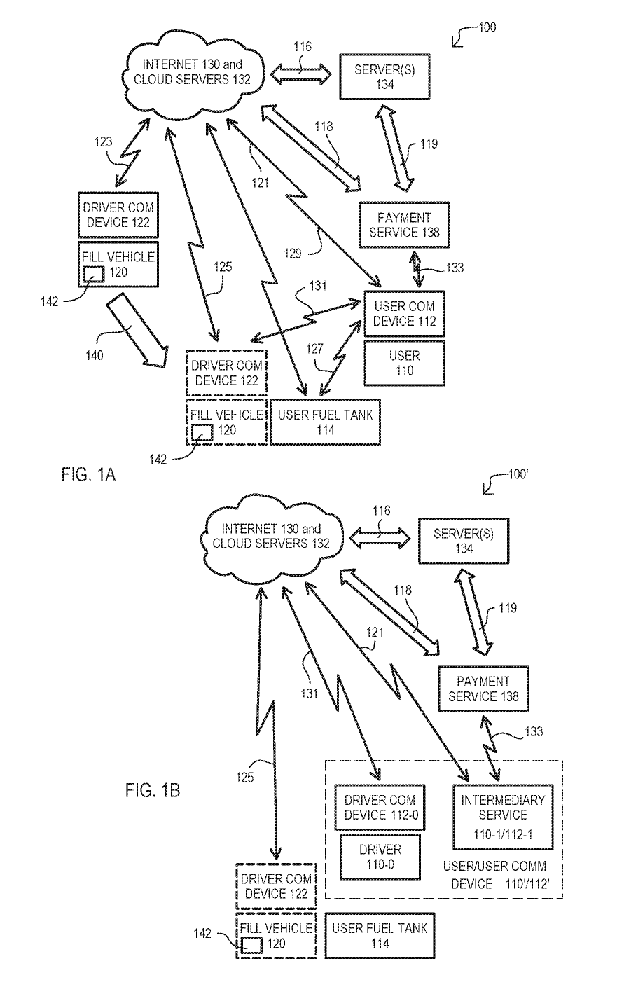

FIG. 1A is diagram showing elements of a fuel delivery system 100 suitable for delivery of fuel to a fuel tank according to one embodiment. Fuel delivered can include but is not limited to selected grades of gasoline or diesel, biofuels, hydrogen, or propane. In the particular embodiment shown, a user 110 can be equipped with a user communication device 112, and desires to have an amount of fuel placed into a user fuel tank 114 that is situated at a determinable location. This will be referred to herein as “refilling”, but is not intended to imply any particular amount of fuel (i.e., a tank is completely filled). Using communication device 112, the user 110 can contact a service via a communications network, such as the Internet 130. A service can have business, sales, or other data services on cloud servers 132 and/or on servers 134 owned and/or operated by the service that can be connected to the communications network (e.g., 130) by a server communications path 116. In some embodiments, any of servers 132 or 134 can connect to third party payment services 138. Such a connections can include a network communications path 118 or a direct communications path 119.

Using a suitable application, web interface, or other user interface on communication device 112, the user 110 can request (via communication pathway 121) delivery of a specified fuel type to a fuel tank 114.

According to methods described in more detail herein, in response to the user request, a delivery can be scheduled or confirmed for a designated time or time window (e.g. any time between 1:00 PM and 3:00 PM). In some embodiments, a user can be identified and/or authenticated. If not already available or confirmed by the user, identifying information for the fuel tank 114 can be requested and/or acquired. Such actions can be performed by operation of servers (132 and/or 134). Based on predetermined criteria, one or more fill vehicles 120 (i.e., vehicles which can deliver the requested fuel) can be provided (via communications pathway 123) with delivery information. Such data/criteria can include, but is not limited to, availability and/or location of fill vehicles, fill vehicle inventory (fuel or other), type of fill vehicle, traffic data (real time, historical, or other), a service level (assigned to user, or requested by user). Delivery information can include, but is not limited to, a time, time window, expected or estimated fuel amount and type, and exact or approximate expected location of the user fuel tank 114. According to some embodiments, generation and/or transmission of delivery information can be performed by servers (132 and/or 134).

In response to delivery information, a fill vehicle 120 can move from a first location to a second location near to the user fuel tank 114, as indicated by dotted outlines of boxes 122′/120′ and arrow 140. Such movement can be via a driver 122 or can be via autonomous navigation. A user fuel tank 114 can then be refilled with fuel provided by the fill vehicle 120′. Using the driver communication device 122 or a vehicle equipped communication device, information relating to the refill operation can be sent (via communication pathway 125) to servers 132 or 134. Such refill operation information can include, but is not limited to, success of the refill operation and the amount of fuel delivered. In some embodiments, a transaction can be completed using payment service 138. In other embodiments, payment 138 can have been made prior to delivery of fuel.

Once a delivery operation has been completed or otherwise terminated, a fill vehicle 120′ can be ready to continue to a next scheduled fuel tank refill location, or proceed to a predetermined staging/wait location.

While embodiments can include users 110 that request refill services via a communications network (e.g., 130), in addition or alternatively, a user 110 can directly contact a fill vehicle 120 (or driver of such a vehicle) for a fuel delivery request (via communication pathway 131), and make payments directly to the driver (or fill vehicle 120′) or to the payment service 138 (via communication pathway 133).

As will be appreciated, user 110 can include but is not limited to being owner of a fuel tank, a primary driver of a vehicle having a fuel tank, authorized family member, employer or employee of the primary driver, a business partner of the driver (e.g., transportation network company), manager of vehicle fleet or building site, or any agents thereof. Identification of a user 110 can be through possession of a designated communication device, through passwords or biometric authentication, or by other suitable enrollment and/or authentication procedures. In some embodiments, a user 110 can have identifying password and payment information that is used in conjunction with a password protected smartphone, tablet, or computer to connect to servers 132 and/or 134 and initiate the fuel delivery process. Acknowledgement of fuel delivery order receipt, indication of successful refueling, or receipts for payment can be sent to the user or a designated receiving and tracking agent(s). According to some embodiments, such actions can be performed by servers (132 and/or 134).

Both the user communication device 112 and driver communication device 122 can be a smartphone, tablet or computer with Internet access. In certain embodiments a dashboard mounted vehicle computer and communication system can be used, either directly or through contact with Bluetooth or similar connected smartphone that provides communication services for the vehicle computer. Alternatively, cell or landline phones connectable to a call or dispatch center can be used. In some embodiments, a communication device 112 or 122 can include a user interface comprising a software application text-based, graphical, or voice interface, or combination thereof. Such a user interface can be accessible by the user through a smartphone application such as are provided for Android™ or iPhone™ applications.

A user fuel tank 114 can be a fixed, portable, or semi-portable stand-alone tank, or included in a vehicle. Fixed or semi-portable tanks to hold the fuel can include fuel tanks intended to supply home, commercial, or industrial electrical back-up generators, or in certain embodiments, a vehicle fuel supply station or depot, as but a few examples. In other embodiments, a user fuel tank 114 can be an automobile, truck, motorcycle, or recreational vehicle. Stand-alone or vehicle mounted fuel tanks can be identified by location, labelling (including bar or QR codes), or by characteristics including model, make, color, license plate, or vehicle identification number (VIN). In certain embodiments electronic identification can be provided by attachments to the fuel tank, including RFID tags, near field communication tags, Bluetooth, or other available electronic tag system. In some embodiments, the electronic control system of the vehicle can be used to positively identify the vehicle and associated fuel tank. Access to the fuel tank is possible through simple opening of a fuel tank inlet port, by keyed entry, or by electronic open/close systems. If the fuel tank inlet port is lockable, the fill vehicle driver will require that the user 110 leave the inlet port unlocked, or provide them with the necessary mechanical keys or electronic unlock key codes.

In some embodiments, there can be a communication path associated with a user fuel tank 114. In the particular embodiment shown, there can be a fuel tank communication path 127 between a user fuel tank 114 and a user communication device 112 and/or a fuel tank communication path 129 between a user fuel tank 114 and a server (132 and/or 134) or payment service 138.

In some embodiments a fill vehicle 120 can be a truck capable of refilling a user tank to a desired level. In particular embodiments, a fill vehicle can be a light truck with a haul capacity of less than 10,000 lbs. having one or more permanent or removably mounted fueling tanks 142. According to some embodiments, fueling tank(s) 142 can have a fuel capacity of between 10 gallons and 7000 gallons, and in particular embodiments between about 30 gallons and 120. A fill vehicle can include multiple fueling tanks 142 to convey multiple fuel types and/or to carry additional fuel of the same type. In certain embodiments a fueling tank 142 can be connected to smaller tanks that incorporate additives to modify desired fuel characteristics. Fueling tank(s) 142 can includes an electronic or wirelessly connected fuel meter and pump that can convey a volume of fuel delivered to any of: a driver/operator of a fill vehicle 120, the fill vehicle 120 itself, a user communication device 112, server(s) (132 and/or 134), payment service 138, or as will be described in more detail below, an intermediary user. Such communications can be according to any suitable network, including but not limited to 3G, 4G/LET, or any other wireless communication. In some embodiments, data related to a fuel delivery can be recorded in a memory located on the fill vehicle 120 or driver communication device 122.

Data related to a fuel delivery can include any of: price and volume of fuel delivered, time and date of delivery, payment confirmation data, user/tank authentication data, or delivery location data. A memory for storing delivery data can be located in any suitable position of the vehicle, including but is not limited to a pump, fuel meter, or other device, including a driver communication device as noted above. A memory can be a nonvolatile memory, such as flash memory, as but one example. According to some embodiments, data recorded on such memory can be uploaded, either manually or automatically, to other locations, including but not limited to: servers (132 and/or 134) or payment service 138 for processing. In still other embodiments, the electronic fuel pump can be plugged into, or wirelessly interfaced with the driver communication device 122, which in turn provides data related to fuel delivery to other locations, including but not limited to servers (132 and/or 134) which can provide such data directly or indirectly to a user 110 via a messaging service/application, including but not limited to email, a text message service, or an application (e.g., smartphone application) of the user 110.

A payment service 138 can use information such as user bank account information, check routing information, credit/debit card, pre-purchased fuel credit, Bitcoin or other electronic payment system, along with user authentication information, to process a payment related to a fuel delivery. In one embodiment, information that identifies a customer, the customer vehicle or standalone fuel tank, and each fuel refill transaction can be saved in a database on server (132 and/or 134). This information can be reconciled for each transaction with the payment service 138. In such an arrangement, a user can make direct payments for fuel services to the payment service 138, or to have a server (132 and/or 134) authorized to request payment from the payment service 138 as each fuel transaction is recorded.

FIG. 1B is a diagram showing a fuel delivery system 100′ according to another embodiment. A system 100′ can be an alternate embodiment to that of FIG. 1A, and like items are referred to by the same reference characters. FIG. 1B shows how a user and user communication device 1107112′ can include one or more drivers 110-0 and driver communication devices 112-0 in combination with an intermediary service 110-1/112-1. In some embodiments, an intermediary service 110-1/112-1 can be in communication with multiple drivers 110-0 who can be independent contractors or employees of the intermediary service 110-1/112-1. In operations, a driver 110-0 can be communication with intermediary service 110-1/112-1 via a communication path 131/121. While such a communication path can use network 130 in other embodiments there can be a direct communication path to intermediary service 110-1/112-1 (the direct path not shown in FIG. 1B).

In operation, a driver 110-0 can forward a request for refill of a user fuel tank 114 to intermediary service 110-0/112-1. Intermediary service 110-0/112-1 can send a request to server (132 and/or 134) to arrange a refilling operation as described herein, or equivalents. Further, intermediary service 110-0/112-1 can arrange payment for such services via payment service 138 through network 130 and/or direct communication path 133. In some embodiments, intermediary service 110-0/112-1 may not arrange entire payment for refilling, but can provide a discount for a driver 110-0 via communication path 121/125. A driver 110-0 may then may arrange a refilling operation acting as a user, as shown in FIG. 1A, or an equivalent. In particular embodiments, an intermediary service 110-0/112-1 can be a transportation network company. It is further noted that a driver 110-0 need not be a person, but can include an autonomous vehicle.

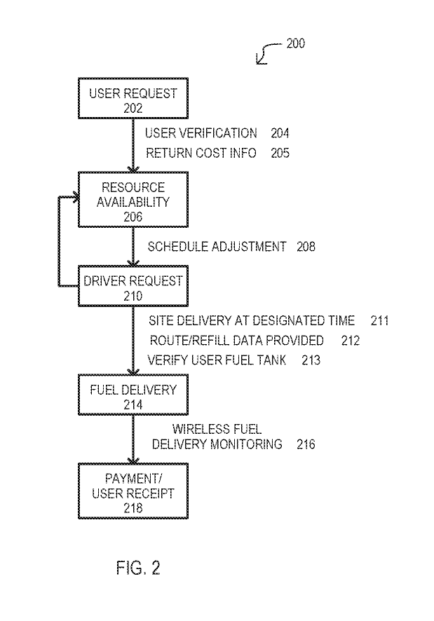

FIG. 2 is a flow chart illustrating a method 200 according to an embodiment. A request can be made by a user 202. Such a request can be for fuel delivery to a user fuel tank, such as a vehicle or stand-alone fuel tank, as but two examples. Such an action can include an electronic transmission, via a network, including the Internet, which can identify a user fuel tank. User fuel tank information can be included in the request or can already be stored and retrieved based on user identification/authentication. In some embodiments, such actions can be include a user communication device.

In the embodiment shown, user verification 204 can verify an identity of a user. In particular embodiments, such an action can include, but is not limited to initiation of a password, challenge/response, biometric (including but not limited to fingerprint, voice or face recognition), or device based authentication. Such authentication can determine a user identity and ability to pay for services, for example. In certain embodiments, requiring active user verification can be a one-time event, with any later orders from the same device (e.g., personal smart phone, vehicle communication system, etc.) providing necessary authentication for the user verification step 204. In some embodiments, such actions can be performed by a server, such as those described herein or equivalents.

Referring still to FIG. 2, estimated or actual cost information for a refill operation can be returned to a user 205. Such cost information can include, but is not limited to: fuel cost, taxes, and any other services (e.g. windshield cleaning) that can be provided in the refill operation. In some embodiments, a return of cost information 205 can also include a request to approve or confirm the refill operation. In some embodiments, such actions can be performed by a server, such as those described herein or equivalents.

A method 200 can also include an automated assessment of resource availability 206. Such an action can be made in response to a user request and/or user approval of refill operation. In particular embodiments, automated assessment of resource availability 206 can include any of: a number of potential fill vehicles, locations of potential fill vehicles, amount and type of dispensable fuel, driver availability, traffic conditions, route time for selected fill vehicles, and available time optimizations for fill vehicle route integration in view of other requests. In some embodiments, multiple customers in a same area can be serviced with a single fill vehicle over the course of a morning than with multiple vehicles delivering fuel at the same time. In some embodiments, such actions can be performed by a server, such as those described herein or equivalents.

A method 200 can include requests for schedule adjustments 208. In some embodiments, such an action can occur after a determination of resource availability has been made. A schedule adjustment 208 can include placing a new refill request within a framework of existing deliveries that have already been scheduled. In some embodiments, deliveries can be centrally controlled, by a server or the like. However, in other embodiments, schedule adjustments 208 can be made by a fill vehicle accepting a request for a delivery.

In the particular embodiments, of FIG. 2, a driver request 210 can be made, with drivers signaling a willingness to add a scheduled delivery to a task list. If a selected driver does not respond within a predetermined time window, another driver can be selected. When a driver is selected for a delivery, a resource availability 206 can be updated.

In some embodiments, a driver can commit to a site delivery of fuel at a designated time 211. Such an action can include a driver responding via an application running on a driver communication device. In response to a driver committing to a delivery, a resource availability can again updated. In some embodiments, route and refill details can be provide 212. In particular embodiments, such an action can include such data being pushed to a driver communication device. In some embodiments, such actions can include a server generating and providing delivery data to driver communication device over a communications network.

A method 200 can further include verifying a user fuel tank 213 (e.g., vehicle or fuel tank). Such an action can include automated and/or manual verification of a user fuel tank 213.

Fuel delivery can be made 214. As fuel is delivered to a user fuel tank, wireless fuel delivery monitoring 216 can occur. In particular embodiments, such actions can include a volume of fuel delivered to a user fuel tank being measured and reported by a wireless fuel delivery monitoring system 216. In particular embodiments, a wireless fuel delivery monitoring system 216 can communicate directly to a server and/or to a driver communication device to provide fuel delivery data. In the latter case, a driver communication device can send fuel delivery data to a server, or the like.

Referring still to FIG. 2, payment can occur along with the generation of a user receipt 218. In some embodiments, this can include communication with a payment service as described herein, or an equivalent. Upon successful payment (or other confirmation of credit or funds) a receipt can be generated. A receipt can be an electronic receipt delivered via a server of the fuel delivery service, the payment service, or both.

Upon completion of a fuel delivery (214), a driver of a fill vehicle can to proceed to a next scheduled refill location. In certain embodiments, finalizing the transaction and user payment can occur as the driver proceeds to the next or any subsequent fuel deliveries.

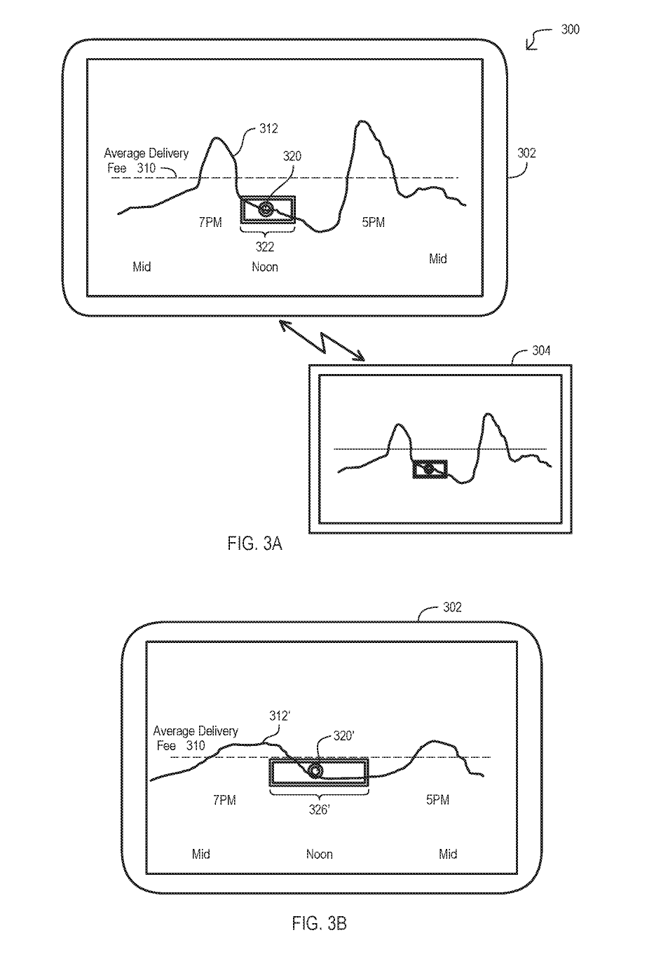

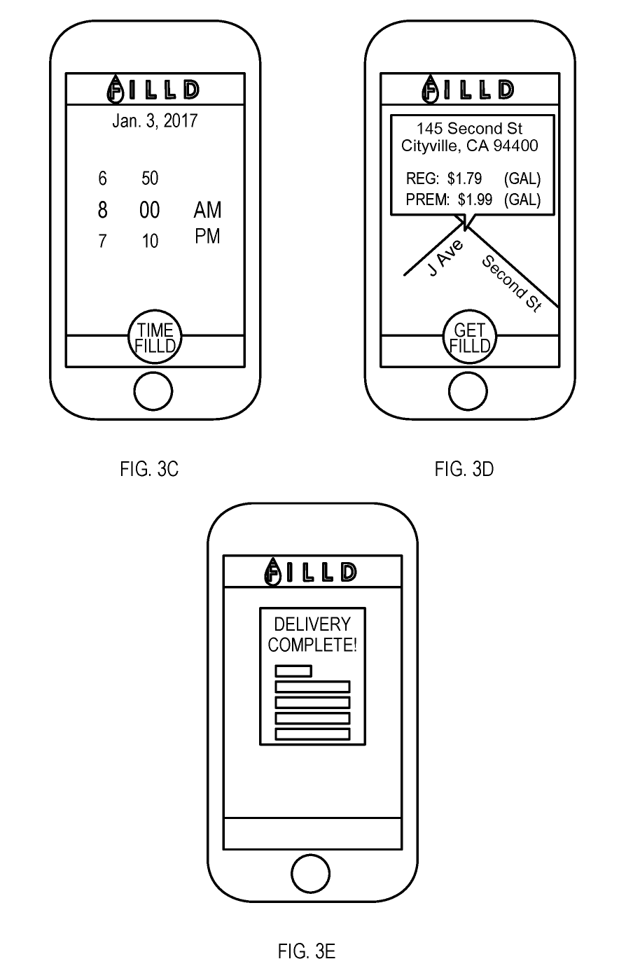

FIGS. 3A and 3B are diagrams of user accessible screens 300, showing methods of making and/or confirming a delivery requests according to particular embodiments. In the embodiment shown, a time of delivery (or time window of delivery), with time variability of prices is shown. A screen 302 can be part of any suitable user device that can communicate with a fuel delivery service as described herein, or an equivalent. In one very particular embodiment, screen 302 can be part of a dashboard navigation and infotainment system of a vehicle.

An interface and/or information like that shown on a screen 302 can be displayed on various other interfaces. As but one example, a screen 302 can be mirrored on a user smartphone with screen 304 running a fuel delivery software application. In a particular embodiment, there can be communication provided by wireless transmission between the devices of screens 302 and 304. A dashboard navigation and infotainment system (e.g., of screen 302) can provide precise details of available fuel and GPS or inertially determined location to the user smartphone (e.g., screen 304), which in turn can provide these details along with user authentication to an on-demand fuel delivery service, as described herein or an equivalent.

According to some embodiments, as shown in screen 302 of FIG. 3A, a particular time of delivery 320 can be selected that includes a sized delivery time window 322, which can be centered on the selected time. A fuel delivery charge 312 can vary over time, due to various factors including but not limited to supply and demand considerations. As but some non-limiting examples, there can be a higher demand early morning pre-workday times and end of workday times, thus these times can have the most costly delivery fees. In some embodiments, other charge information can be shown. In the embodiment of FIG. 3A, an average delivery fee 310 can be shown. While FIG. 3A shows an average as a daily average, alternatively such an average can be, or selected to be, an hourly, weekly, monthly, or annual average.

According to embodiments, visual representations of delivery fees can dynamically change with changes in delivery time window. FIG. 3B shows a resulting display after the delivery time window shown in FIG. 3A has been resized to 322′ (in this case widened). In the example shown, such a widened delivery time window can flatten or smooths the delivery fee 312′ over the day, and can lower user costs since resource scheduling can move deliveries to lower demand delivery times. As will be appreciated, one time, scheduled, or automated orders for fuel delivery with volume or “good customer” discounts are anticipated. For example, a user can make a continuing order for weekend delivery of fuel to a vehicle parked in the user driveway.

FIGS. 3C to 3E are particular examples of interface screens that can be included in embodiments. FIG. 3C shows an interface screen that can provide an estimated delivery and fuel cost to a user. FIG. 3D shows an interface screen that can be used to initiate a user request for a fuel delivery. FIG. 3E shows a screen that can provide a payment receipt. It is understood the various screens shown in FIGS. 3A to 3E are provided by way of example and should not be construed as limiting. Alternate embodiments can present the same, similar, or different information in a different format.

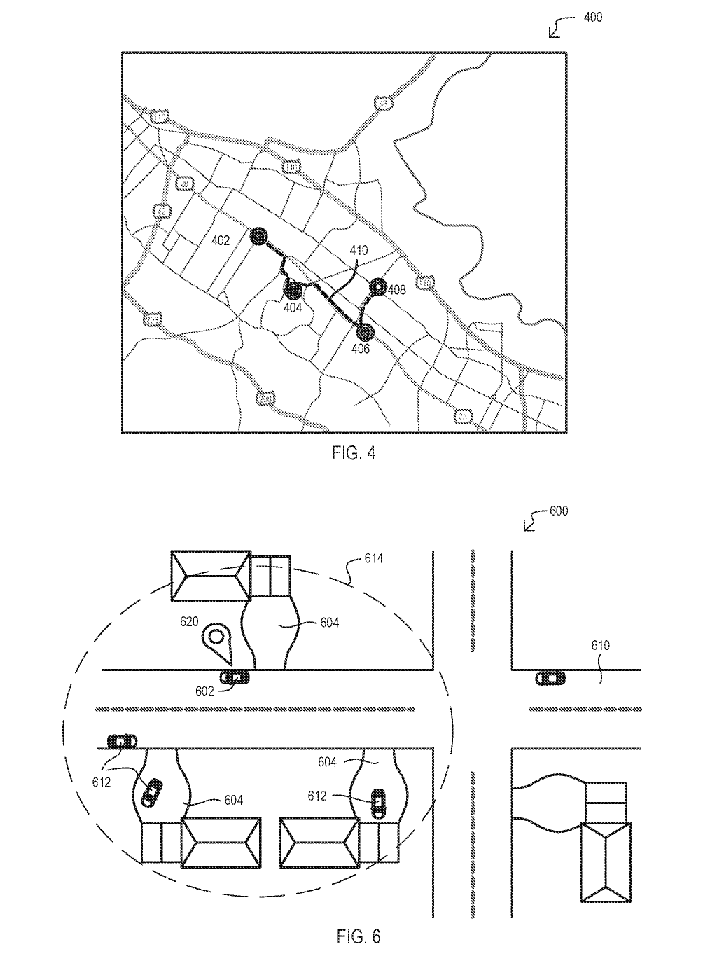

FIG. 4A is an illustration of driver route map 400 that can be generated according to embodiments. FIG. 4A shows various roads of a region that can be covered by a fueling service. Locations for user fuel tanks (e.g., vehicles) can be indicated by markers (in this case rings) 402, 404, 406, and 408. Such locations can be approximate locations and/or relatively exact locations. A generated route 410 connect locations. In some embodiments, a route 410 can time periods and/or markers associated with it. In a particular embodiment, such time periods/markers can include an expected arrival time for each user fuel tank, an expected time to finish fueling. In certain embodiments, the driver can only receive information concerning a current and next destination (e.g., ring position 402 and 404), with additional information only be provided after a fuel delivery (e.g., refill) is accomplished or otherwise terminated. Advantageously, such embodiments can simplify screen display and minimize possible driver confusion when later delivery events are rescheduled or moved.

FIG. 4B is a diagram showing a driver route scheduling method 450 according to an embodiment. A method 450 can be executed by a server of a fuel delivery system. When scheduling driver routes, any of distance, route complexity, traffic, available fuel for delivery, fuel state of the fill vehicle, available drivers, customer preferences, and additional required services can be considered before assigning a driver route. A method 450 can begin with a current or anticipated location of the user vehicle 452. Such an action can include receiving a fuel delivery request that includes location data and/or retrieving previously stored data.

Available fill vehicles can be determined 454 and an available fill vehicle selected 456. Fill vehicle selection 456 can be based on various optimality criteria including but not limited to: driver schedule and route considerations, efficiency, cost, or time constraints. A determination can be made on whether a fill vehicle can meet a delivery window 460. In some embodiments, any of map and current or historical traffic data can be considered to make such a determination. If a determination has been made that no fill vehicle can make the delivery window, a user can be asked to choose another time window 462. If a fill vehicle is available, a global plan (e.g., a distance map) can be created 464 for movement of the fill vehicle. In particular embodiment shown, a local planner 468 can combine with the global plan with integrated traffic data or other relevant information such as parking considerations to more precisely create a guide map 466 for the driver.

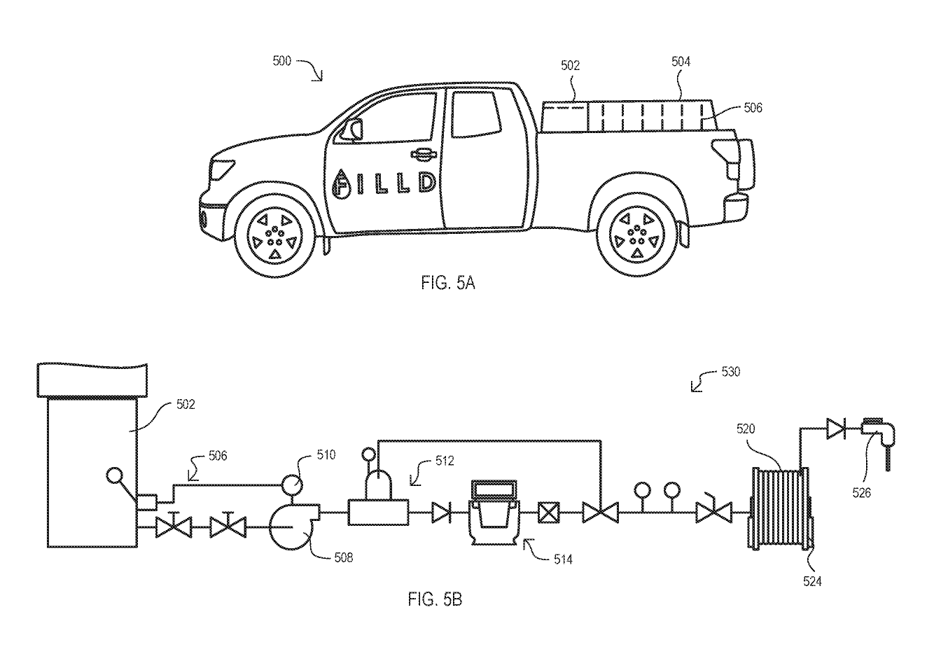

FIG. 5A is an illustration of one embodiment of a fill vehicle 500. A fill vehicle 500 can be based on a light truck modified to hold modular fuel tanks (in this embodiment, two 502 and 504). Fuel tanks can have interior baffles to reduce unwanted sloshing or movement of fuel in the tanks. The fuel tanks can be separately attachable to a fuel pump, or in other embodiments can be interconnected to permit pumping from a single tank to empty both tanks. The fuel tanks 502 and 504 can be single walled, or in certain embodiments, can have double walls to reduce risk of leakage or other effects. In particular embodiments, fuel tanks can be arranged in an “L” shape, with one fuel tank 502 attached to extend laterally across a bed of the light truck, and fuel tank 504 attached to extend longitudinally along the bed of the truck. In other embodiments (not shown), the tanks can be mounted side by side, either laterally or longitudinally, and positioned adjacent or separated. In some embodiments, tanks can be of similar size, but in other embodiments one or more fuel tanks having different sizes, shapes, and overall fuel capacity can be used. In some embodiments, a fill vehicle could be equipped with one large tank with regular grade gasoline, a smaller tank with higher grade gasoline (capable of being mixed with the regular grade gasoline to form an intermediate grade gasoline), and still smaller tank to carry diesel, biodiesel, or other specialty fuel types. In still other embodiments, non-rectangular or non-prismatic shapes including cylindrical, partially cylindrical, or spherical fuel tanks can be used. Small portable tanks can also be used to carry specialty fuels or fuel additives, or to allow for fuel delivery if a vehicle is not accessible with pumped fuel hose and nozzle.

FIG. 5B is a schematic diagram of fuel delivery components 530 that can be included in embodiments. Fuel delivery components can be included on a fill vehicle, such as that shown in FIG. 5A. Fuel delivery components 530 can include a tank 502, tank connection assembly 506, and pump assembly 508. In some embodiments, a tank connection assembly 506 that can include liquid level control devices, a safety valve, and an isolation valves. When valves of a tank connection assembly are open, fuel can be pumped using a pump assembly 508 powered by a pump motor 510. A pump assembly 508 can send fuel to a fuel strainer and vapor eliminator 512.

Referring still to FIG. 5B, fuel can flow through a flow meter with electronic register 514, which can measure a volume of fuel delivered. Fuel can be delivered to a user fuel tank (e.g., vehicle) through a hose 520 and fuel nozzle 526. In the embodiment shown, a hose 520 can be compactly carried on a hose reel 524 when not in use. In the embodiment shown, flow meter and electronic register 514 can be positioned after fuel strainer and vapor eliminator 512 and before hose 520, however such equipment can be located in any suitable position in a fuel flow path.

In operation, flow meter and electronic register 514 can record a volume of fuel dispensed into a user fuel tank. A volume of fuel dispensed and the price of the fuel dispensed can be electronically transmitted, directly or indirectly, to a server and stored. Such data can be used by a server to initiate payment transactions for the fuel delivered, as well as any other related charges including, but not limited to, taxes and delivery charges. Direct data transmission can include communication with a server using a 4G LTE or similar network, while indirect communication can include wired or wireless transfer to a smart phone, laptop, or tablet using Blu-tooth, Wi-Fi, or similar short range transmission protocols, as but a few examples.

While a location of a user fuel tank can be a predetermined place, or easily determinable, according to embodiments, an application can include a position selection interface to more precisely identify a location of a user fuel tank. One such embodiment is shown in FIG. 6.

FIG. 6 is a cartoon illustrating a “pin” selection of user vehicle, which can be a target vehicle 602 to be fueled in a residential neighborhood 600 having multiple driveways 604 and parking on streets 610. A user (not shown) can be in a location away from a target vehicle 602, such as in a residence or away from home. A user can request fuel delivery via any suitable method, and in some embodiments a smartphone. For example, a user can request a late night vehicle fuel refill. Since a user is not in the target vehicle 602, a smartphone associated GPS, cell phone, or wireless location service may not be capable of precisely identifying an actual location or position of the target vehicle 602. If residence information is used, other vehicles 612 parked in the driveway or on the street may be incorrectly selected for refill, causing delay or confusion to the fill vehicle driver. To minimize such problems, according to embodiments, a user can use a mapping feature included in a software application to unambiguously mark location of the target vehicle 602. In some embodiments, such a marking can occur at a time of requesting a fuel delivery.

Referring still to FIG. 6, an area 614 can be identified by an application and presented to a user. A user can then manipulate a graphical marker 620 to indicate a position of the target vehicle 602. A graphical marker 620 can take any suitable form, including a pin, dot, lighting bolt, or similar indicia can be used to identify the vehicle, with the marked position being user updatable if the target vehicle 602 is moved to a new area before fuel delivery. Position data provided by user can be transmitted to the assigned fill vehicle to enable precise identification of the user fuel tank (i.e., target vehicle) position.

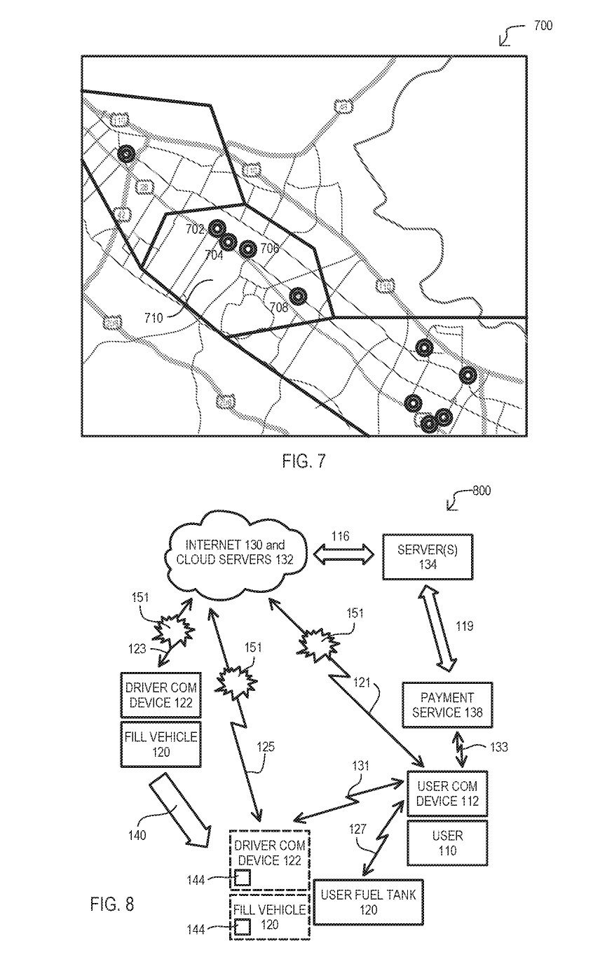

In addition to dynamically updating delivery charges as discussed with respect to FIGS. 3A and 3B, a cost of delivered fuel cost can also substantially vary due to geographic considerations and pricing policies of local gasoline stations. A server can store and/or acquire gas price data to establish gas price monitoring zones having fuel prices that can vary according to local prices. FIG. 7 is one representation of such operations. FIG. 7 shows a geographical region 700 divided into gas price monitoring zone, one such zone is shown as 710, and can include four selected gas station shown as 702, 704, 706, and 708. Gas prices can be monitored for each of the gas stations (702, 704, 706, and 708), and such prices can be used by a server to calculate an average fuel price for fuel deliveries in the zone 710, such as an average fuel price, in some embodiments.

In alternative embodiments, gas price averages can be calculated with a predetermined radius, within a predetermined drive distance, within predetermined drive time, or by any other suitable mechanism for linking fuel costs to the delivery location.

FIG. 8 illustrates direct driver to user communication of a fuel receipt in the event of a communication, server, or cloud server failure, according to an embodiment. FIG. 8 shows a fuel delivery system 800, like that of FIG. 1A, and like items are referred to by the same reference characters.

In the event of a communication failure (indicated by jagged clouds 151 in wireless communication links 123, 125, and 121) in the cloud servers or company servers 134, a fill vehicle driver can still complete the transaction by direct engagement with the user communication device 112. Data for such a transaction can be stored in a memory 144 in a fill vehicle 120 and/or driver communication device 122. At a later point in time, reconciliation with the payment service 138 and servers 132 or 134 can be made using such data. Such an ability can be of particular use in areas prone to cell phone “dropouts” or at high demand areas (e.g. in the vicinity of a stadium or airport) that can have poor data service.

In operation, a user 110 equipped with user communication device 112 desires to refill a user fuel tank 114 that is situated at a determinable location. Using communication device 112, user 110 can contact Internet 130 connected service that has business, sales, or other data services on cloud servers 132 or business owned and operated servers 134. Servers 132 or 134 can optionally connect to third party payment services 138. Delivery can be scheduled for a designated time or time window, and a fill vehicle 120 with a driver communication device 122 can be provided (via communication pathway 123) with a driver route. Such actions can be according to any of the embodiments shown herein, or equivalents.

Even when communication with the servers 132 and 134 is interrupted, a fill vehicle 120 can still verify that the user still desires refill by direct communication with the user or user application on user communication device 112. Using the driver communication device 122, information relating to success of the refill operation, and amount of fuel delivered is sent to the user (via communication pathway 131) and also stored in memory 144 for subsequent sending to servers 132 or 134 when communication is possible. The transaction can be completed by direct payment by the user to payment service 138 (via user communication pathway 133), and the fill vehicle can be ready to continue to a next scheduled fuel tank refill location using driver route information earlier stored on the driver communication device 122.

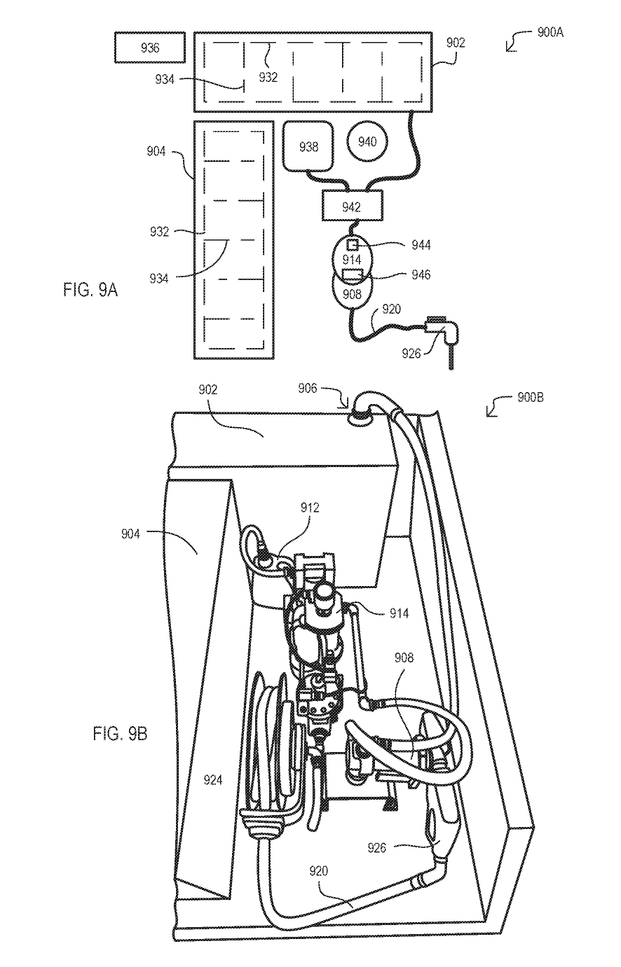

FIG. 9A is a block diagram showing fuel delivery components 900A according to an embodiment. Such components can be mounted in a fill vehicle. Components 900A can include primary fuel tanks 902/904 which can optionally include a double lining 932 and/or internal baffles. One or more secondary tanks 936 can be included to provide an additive, or a different grade of fuel and/or a different type of fuel than primary fuel tanks 902/904. Specialty tank 940 can include a specialty fuel that is rarely pumped or not pumped. In the embodiment shown, a mixer 942 can be included to mix fuels with each other or with additives. In the particular embodiment shown, fuel in primary tank 902 can be mixed with material in secondary tank 936 (e.g., an additive or a different grade fuel). A mixer 942 can include a no mixing (i.e., bypass) output paths (i.e., direct routes for fuel in primary fuel tank 902 or secondary tank 936).

An output from mixer 942 can be provided to electronic register 914. In the embodiment shown, electronic register 914 can include a nonvolatile memory 944 for storing fueling operation data and a fuel meter 946 to record a volume of fuel output to a user fuel tank. Optionally, electronic register 914 can include a communication path (wired or wireless) to driver communication device 936. Driver communication device 936 can communicate with servers or the like as described herein or equivalents. In addition or alternatively, electronic register 914 can include communication devices for communication with servers without need of driver communication device 936. A pump assembly 908 can pump fuel through hose 920 to nozzle 926, to enable a user fuel tank to be filled.

FIG. 9B is a top view illustration of selected fuel delivery components 900B according to another embodiment. Primary fuel tank 902 can be positioned next to primary fuel tank 904. The primary fuel tank 902 can be connected to a tank connection assembly 906 that can include liquid level control devices, a safety valve, and an isolation valves. When the valves are open, fuel can be pumped using a pump assembly 908. A pump assembly 908 can send fuel to a fuel strainer and vapor eliminator 912, followed by passage through a flow meter with electronic register 914. In this embodiment, data signals are transferred by wire to a readout assembly in a cab of a truck carrying the tanks, and then wirelessly retransmitted to a driver's smart phone, tablet, computer, or directly to cloud servers using a 4G LTE or similar connection. In other embodiments, an electronic register can directly send wireless data via 4G LTE, or send locally to a smart phone, tablet, or computer. After having volume measured using National Conference on Weights and Measures (NCWM) or other geographic specific weight and measures compliant flow meter, fuel can be delivered to a vehicle through hose 920 and connected fuel nozzle, with the hose 920 being compactly carried by a hose reel 924 when not in use.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

What is claimed is:

1. A user on-demand fuel delivery system, comprising:
at least one fill vehicle having a fuel tank connected to an electronically readable fuel flow meter; and
at least one server configured to receive user instructions for refill of a fuel tank, including actual or anticipated location of the fuel tank, and a time window for fuel refill, wherein the at least one server selects one of the fill vehicles and provides route and time information to the fill vehicle for refill of the fuel tank;
wherein the electronically readable fuel flow meter provides fuel delivery volume data to the at least one server, and a payment receipt is generated.

2. The user on-demand fuel delivery system of claim 1, wherein the fill vehicle further comprises multiple fuel tanks.

3. The user on-demand fuel delivery system of claim 2, wherein the multiple fuel tanks carry different fuel types.

4. The user on-demand fuel delivery system of claim 1, wherein the fill vehicle further comprises modular fuel tanks.

5. The user on-demand fuel delivery system of claim 1, wherein the fill vehicle is a light truck with a haul capacity of less than 10,000 lbs.

6. The user on-demand fuel delivery system of claim 1, wherein the fill vehicle further comprises multiple fuel tanks, with each tank holding between 30 gallons and 120 gallons of fuel.

7. A user initiated on-demand fuel delivery method comprising the steps of:
receiving a user request for fuel delivery to a fuel tank at a user identified location within a user determined time window;
providing estimated delivery and fuel cost to the user;
assessing resource availability to supply requested fuel to the user;
adjusting driver schedule and route to ensure refill of the user fuel tank during the previously determined time window; and
electronically providing fuel volume delivered information to permit payment calculation.

8. The user initiated on-demand fuel delivery method of claim 7, wherein time variability of fuel price is indicated to the user.

9. The user initiated on-demand fuel delivery method of claim 7, wherein the user request is from a user smartphone.

10. The user initiated on-demand fuel delivery method of claim 9, wherein the user smartphone is connectable to a vehicle navigation system.

11. The user initiated on-demand fuel delivery method of claim 9, wherein an application on the user smartphone provides electronic payment for delivered fuel.

12. A user interface for an on-demand fuel delivery, comprising:
at least one screen for initiating a user request for fuel delivery to a fuel tank;
at least one screen for providing estimated delivery and fuel cost to the user at a specified location;
at least one screen for notifying the user of an available time window for fuel delivery; and
at least one screen containing payment receipt based on information provided by an electronically readable fuel flow meter that provides fuel delivery volume.

13. The user interface for an on-demand fuel delivery method of claim 12, wherein the specified user location is at least in part identified by a GPS information from a user smartphone.

14. The user interface for an on-demand fuel delivery method of claim 12, wherein specified user location is at least in part identified by a user.

15. The user interface for an on-demand fuel delivery method of claim 14, wherein specified user location is at least in part identified by a user using a graphical marker movable with respect to a map to identify vehicle location.

16. A fuel delivery payment method, comprising the steps of:
providing a device having a communication link from a driver to at least one of a server and a user smartphone;
electronically providing fuel volume delivered information from an electronically readable fuel flow meter to the device of the driver to permit payment calculation; and
sending a payment calculation to at least one of the server and the user smartphone to complete payment.

17. The fuel delivery payment method of claim 16, wherein the server is a cloud server.

18. The fuel delivery payment method of claim 16, wherein the server is reconciled with a payment service.

19. A fuel delivery system, comprising:
at least one fill vehicle having a multiple fuel tanks;
a pump system connectable to the multiple fuel tanks;
an electronically readable fuel flow meter connected to the pump system, with the electronically readable fuel flow meter being compliant with National Conference on Weights and Measures (NCWM) metering; and
a wireless connection to send information from the electronically readable fuel flow meter to at least one of a cloud server, a company server, and a driver communication device.

20. The delivery system of claim 19, wherein the multiple fuel tanks carry different fuel types having different fuel volume prices.

21. The user on-demand fuel delivery system of claim 1, wherein the fill vehicle is a light truck with a haul capacity of less than 10,000 lbs.
